(19) United States
(12) Patent Application Publication
(10) Pub. No.: US 2026/0058268 A1
(43) Pub. Date: Feb. 26, 2026

(54) SECONDARY BATTERY

(71) Applicant: SK ON CO., LTD., Seoul (KR)

(72) Inventor: Hoe Min CHEONG, Daejeon (KR)

(21) Appl. No.: 19/304,599

(22) Filed: Aug. 20, 2025

(30) Foreign Application Priority Data
Aug. 20, 2024 (KR) 10-2024-0111049
Jul. 23, 2025 (KR) 10-2025-0099717

(51) Int. Cl. H01M 50/188; H01M 10/052; H01M 50/107; H01M 50/152; H01M 50/193

(52) U.S. Cl. CPC H01M 50/188; H01M 10/052; H01M 50/107; H01M 50/152; H01M 50/193

(57) ABSTRACT

A secondary battery according to embodiments of the present disclosure includes a case including a terminal hole that penetrates a top surface thereof; an electrode assembly accommodated in the case; a terminal part inserted into the terminal hole; and a scaling member that extends from the inside of the case to a region between the case and the terminal part, and is disposed between the case and the terminal part.

This application claims priority to Korean Patent Applications No. 10-2024-0111049 filed on Aug. 20, 2024 and No. 10-2025-0099717 filed on Jul. 23, 2025 in the Korean Intellectual Property Office (KIPO), the entire disclosure of which is incorporated by reference herein.

### BACKGROUND

### 1. Field of the Invention

The disclosure of the present application relates to a secondary battery.

### 2. Description of the Related Art

Secondary batteries are batteries that can be repeatedly charged and discharged. With the development of information and communication and display industries, they have been widely applied as power sources for portable electronic communication devices, such as camcorders, mobile phones, and laptop PCs. In addition, battery packs including secondary batteries have recently been developed and applied as power sources for eco-friendly vehicles, such as electric cars.

An electrode assembly may be accommodated in a case to define a secondary battery. For example, the secondary battery may be assembled by inserting the electrode assembly into the case through an opening and sealing the opening.

The opening may be sealed using a cap assembly including a cap plate. For example, an insulator and a gasket may be inserted into the cap assembly and sealed by pressurization using a rivet.

However, during the sealing process, damage may be caused to the secondary battery or a defective assembly may occur, resulting in the formation of a leakage path for an electrolyte or gas, which may reduce the cycle life of the secondary battery.

### SUMMARY

According to an aspect of the present disclosure, a secondary battery with improved structural stability and reliability may be provided.

A secondary battery according to exemplary embodiments of the present disclosure includes: a case including a terminal hole that penetrates a top surface thereof; an electrode assembly accommodated in the case; a terminal part inserted into the terminal hole; and a sealing member that extends from the inside of the case to a region between the case and the terminal part, and is disposed between the case and the terminal part.

In some embodiments, the sealing member may extend along an inner surface of the case, a side surface of the terminal hole, and the top surface of the case.

In some embodiments, the terminal part may include an exposure part disposed on the top surface of the case and an insertion part inserted into the terminal hole.

In some embodiments, the sealing member may extend along an inner surface of the case and a side surface of the insertion part.

In some embodiments, a diameter of the exposure part may be equal to a diameter of the insertion part, and the sealing member may further extend along a side surface of the exposure part.

In some embodiments, a diameter of the exposure part may be greater than a diameter of the insertion part, and the sealing member may further extend along the top surface of the case.

In some embodiments, a diameter of the exposure part may be greater than a diameter of the insertion part, and the sealing member may further extend along the top surface of the case and a side surface of the exposure part.

In some embodiments, a length by which the sealing member protrudes outward from the exposure part may be 1 mm to 3 mm in a plan view.

In some embodiments, the sealing member may entirely enclose a side surface of the terminal part.

In some embodiments, the sealing member may electrically insulate the electrode assembly and the top surface of the case.

In some embodiments, at least a portion of the sealing member may be exposed on the top surface of the case.

In some embodiments, the sealing member may include a polymer.

In some embodiments, the sealing member may include at least one selected from the group consisting of high-density polyethylene, perfluoroalkoxy, a silicone polymer, and polybutylene terephthalate.

In some embodiments, the sealing member may be insert-molded into the terminal part.

In some embodiments, the case may include an opening that faces the top surface.

In some embodiments, the secondary battery may further include a cap plate disposed in the opening and coupled to the case.

According to an embodiment of the present disclosure, the structural stability of the secondary battery may be improved.

According to an embodiment of the present disclosure, the operational reliability of the secondary battery may be improved.

The secondary battery of the present disclosure may be widely applied in green technology fields, such as electric vehicles, battery charging stations, as well as solar power generation, wind power generation, and the like, which use the batteries. The secondary battery of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic exploded perspective view of a secondary battery according to exemplary embodiments;

FIG. 2 is a schematic perspective view of the secondary battery according to exemplary embodiments;

FIGS. 3 to 5 are schematic cross-sectional views of the secondary battery according to exemplary embodiments;

FIG. 6 is a schematic plan view of the secondary battery according to exemplary embodiments, as viewed from the top; and

FIGS. 7 to 9 are schematic perspective views for describing a method for manufacturing a sealing member included in the secondary battery according to exemplary embodiments.

### DETAILED DESCRIPTION

Embodiments of the present disclosure provide a secondary battery.

Hereinafter, embodiments of the present disclosure will be described in detail with reference to the drawings. However, the embodiments are merely illustrative, and the present disclosure is not limited to the specific embodiments described by way of example.

As used herein, the terms “top surface,” “bottom surface,” “side surface,” “inner surface,” and “outer surface,” and the like are used in a relative sense to distinguish the positions of components, and do not specify absolute positions.

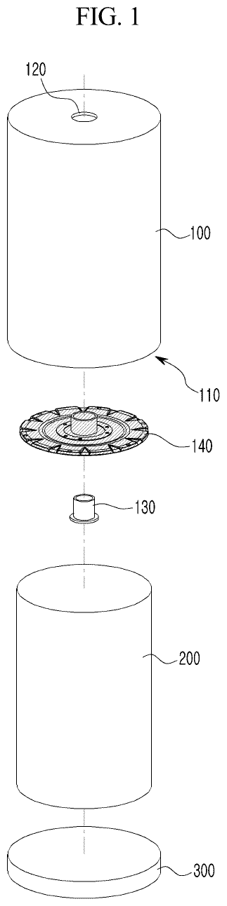

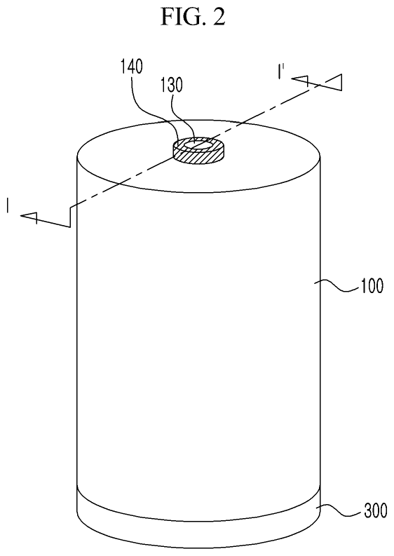

FIG. 1 is a schematic exploded perspective view of a secondary battery according to exemplary embodiments. FIG. 2 is a schematic perspective view of the secondary battery according to exemplary embodiments.

Referring to FIGS. 1 and 2, the secondary battery may include a case 100 including a terminal hole 120 that penetrates a top surface thereof, an electrode assembly 200 accommodated in the case 100, a terminal part 130 inserted into the terminal hole 120, and a sealing member 140 disposed between the case 100 and the terminal part 130.

The case 100 may be provided as at least a portion of the outer surface of the secondary battery. In one embodiment, the case 100 may include a metal. Accordingly, impact to the electrode assembly 200 may be mitigated.

In some embodiments, the case 100 may include an opening 110 that opposes the top surface. The secondary battery may further include a cap plate 300 disposed in the opening 110 and coupled with the case 100.

For example, the cap plate 300 may be provided as a bottom surface cover of the secondary battery. For instance, the cap plate 300 may include a plate-shaped cover and holes that penetrate the cover. An electrolyte may be injected through the holes, or gas generated within the secondary battery may be discharged.

In some embodiments, the cap plate 300 may further include an auxiliary terminal part inserted into the holes.

The configuration and structure of the cap plate 300 are not limited to those described above, and any cover or cap plate structure known in the secondary battery field may be applied thereto without limitation.

The secondary battery may be manufactured, for example, in a cylindrical shape using a can, a prismatic shape, a pouch shape, or a coin shape. For example, various types of secondary batteries may be provided depending on the shape of the case 100 and the electrode assembly 200.

Although a cylindrical secondary battery is shown in FIGS. 1, 2 and 6 as an example, the secondary battery of the present disclosure is not limited to the cylindrical secondary battery and may be applied to the above-described various types of secondary batteries.

The case 100 may include a receiving part configured to accommodate the electrode assembly 200. For example, the opening 110 may be formed on a surface of the case 100 that opposes the top surface, thereby allowing the case 100 to be opened. The electrode assembly 200 may be accommodated in the receiving part through the opening 110.

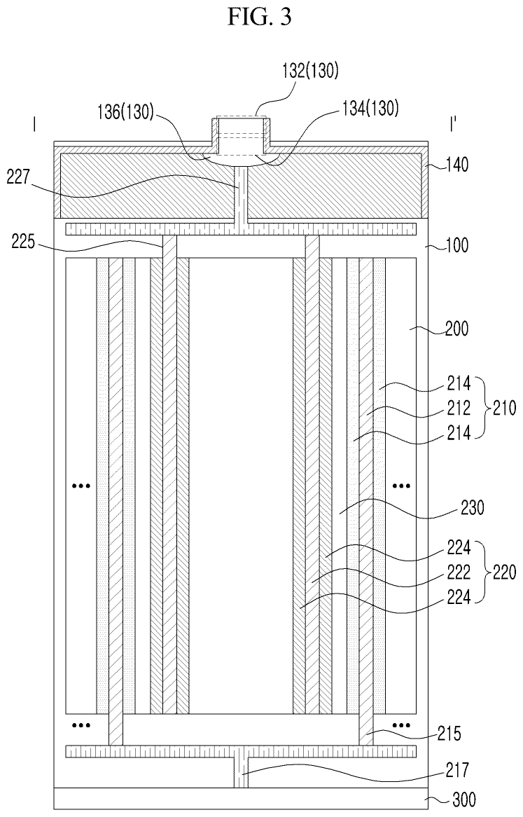

The detailed configuration of the electrode assembly 200 will be described below with reference to FIG. 3.

In exemplary embodiments, the internal space (e.g., the receiving part) of the case 100 may be connected to the outside in a limited manner through the terminal hole 120.

In exemplary embodiments, the terminal part 130 and a portion of the sealing member 140 may be inserted into the terminal hole 120.

According to some embodiments, the terminal part 130 may include a rivet. For example, the secondary battery may be sealed by a riveting process in which the terminal part 130 and the sealing member 140 are inserted and pressurized into the terminal hole 120.

However, it is not limited thereto, and the terminal part 130 may include any member that can be inserted into and secured within the terminal hole 120 without limitation.

For example, the terminal part 130 may include a conductive member. For example, the terminal part 130 may include a metal or an alloy member. Accordingly, the terminal part 130 may be electrically connected to the electrode lead and function as an electrode terminal.

According to exemplary embodiments, the sealing member 140 may be disposed between the case 100 and the terminal part 130. For example, the sealing member 140 may be formed integrally with the terminal part 130.

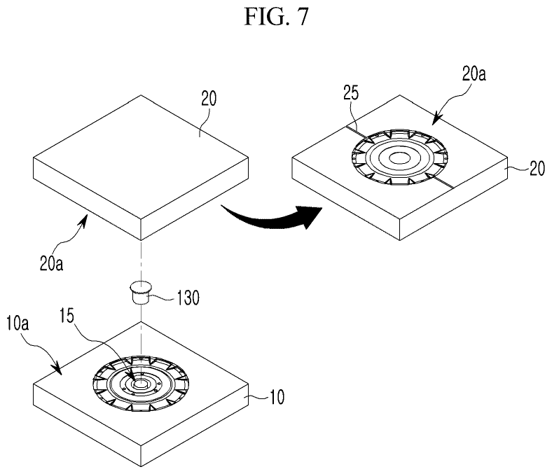

In some embodiments, the sealing member 140 may be formed integrally with the terminal part 130 by insert injection molding into the terminal part 130. The insert injection process of the sealing member 140 will be described in more detail below with reference to FIGS. 7 to 9.

For example, the sealing member 140 may extend from the inside of the case 100 to a region between the case 100 and the terminal part 130. This may prevent lifting at the coupling portion between the terminal part 130 and the top surface of the case 100, thereby improving the sealing characteristics of the secondary battery. Consequently, the structural stability of the secondary battery may be enhanced, electrolyte leakage may be prevented, and operational reliability may be improved.

In some embodiments, the sealing member 140 may include a polymer. For example, the polymer may include an insulating material.

For example, the sealing member 140 may include at least one selected from the group consisting of high-density polyethylene (HDPE), perfluoroalkoxy, a silicone polymer, and polybutylene terephthalate. Accordingly, the sealing properties of the secondary battery may be further enhanced, and the top surface of the case 100 and the electrode assembly 200 may be electrically insulated. Consequently, the stability and reliability of the secondary battery may be further improved.

FIGS. 3 to 5 are schematic cross-sectional views of the secondary battery according to exemplary embodiments. Specifically, FIGS. 3 to 5 are cross-sectional views taken along line I-I′ of FIG. 2 in the longitudinal direction of the secondary battery, respectively.

Referring to FIGS. 3 to 5, in some embodiments, the sealing member 140 may extend along the inner surface of the case 100, the side surface of the terminal hole 120, and the top surface of the case 100. Accordingly, the space between the terminal part 130 and the case 100 may be filled with the sealing member 140 without a separate gasket. Thus, the sealing characteristics of the secondary battery may be improved.

In some embodiments, the terminal part 130 may include an exposure part 132 disposed on the top surface of the case 100 and an insertion part 134 inserted into the terminal hole 120. In some embodiments, the terminal part 130 may further include a head part 136 extending along the inner surface of the case 100 and the side surface of the insertion part 134. For example, the exposure part 132, the insertion part 134, and the head part 136 may be provided as an integral structure formed from substantially the same material.

In some embodiments, the sealing member 140 may extend along the inner surface of the case 100 and the side surface of the insertion part 134. Accordingly, the sealing member 140 may sufficiently seal the coupling part between the terminal part 130 and the case 100, thereby further improving the stability of the secondary battery.

Referring to FIG. 3, a diameter of the exposure part 132 of the terminal part 130 may be substantially equal to that of the insertion part 134. In this case, the sealing member 140 may further extend along the side surface of the exposure part 132 and be exposed on the top surface of the case 100. Accordingly, the sealing characteristics of the terminal part 130 and the case 100 may be further improved.

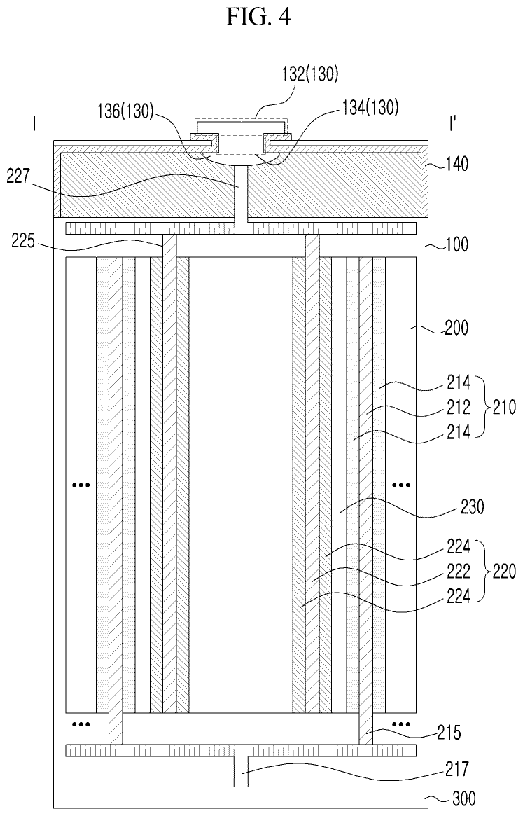

Referring to FIG. 4, the diameter of the exposure part 132 of the terminal part 130 may be greater than the diameter of the insertion part 134.

In some embodiments, the sealing member 140 may extend further along the top surface of the case 100. For example, the sealing member 140 may extend along the inner surface of the case 100, the side surface of the insertion part 134, and the top surface of the case 100. For example, the sealing member 140 may be disposed between the exposure part 132 and the top surface of the case 100. Accordingly, the sealing characteristics of the terminal part 130 and the case 100 may be further improved.

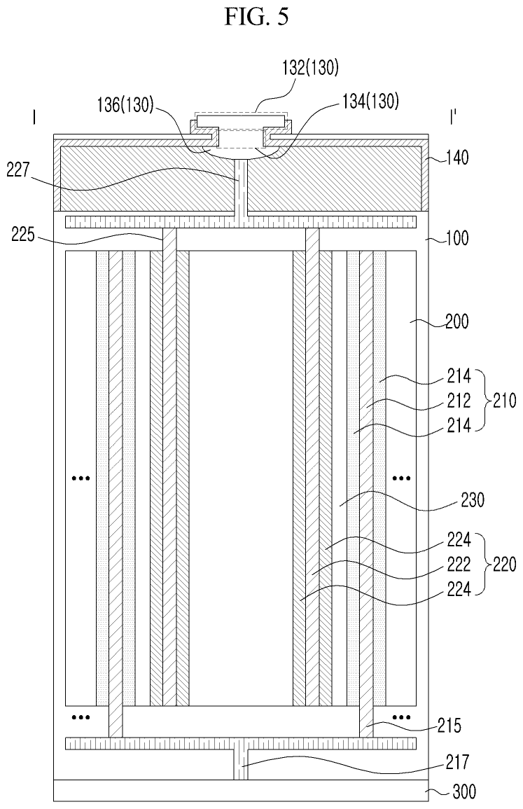

Referring to FIG. 5, the sealing member 140 may extend further along the top surface of the case 100 and the side surface of the exposure part 132. For example, the sealing member 140 may extend along the inner surface of the case 100, the side surface of the insertion part 134, the top surface of the case 100, and the side surface of the exposure part 132. Accordingly, the sealing characteristics of the terminal part 130 and the case 100 may be further improved.

In some embodiments, the sealing member 140 may entirely enclose the side surface of the terminal part 130. Accordingly, the sealing properties of the terminal part 130 and the case 100 may be further improved.

In one embodiment, the sealing member 140 may entirely enclose the inner surface adjacent to the top surface of the case 100, the inner surface facing the top surface of the case 100, and the side surface of the terminal part 130. Accordingly, the operational stability and reliability of the secondary battery may be further improved.

In some embodiments, the sealing member 140 may electrically insulate the electrode assembly 200 and the top surface of the case 100. For example, the sealing member 140 may extend along the inner surface of the case 100 facing the top surface and may be disposed between the electrode assembly 200 and the top surface of the case 100. Accordingly, a short circuit and/or leakage of the secondary battery may be prevented, and stability may be improved without a separate insulator or insulating layer.

The sealing properties and stability of the secondary battery may be improved through the sealing member 140 without using a separate gasket or insulating layer.

In exemplary embodiments, the electrode assembly 200 may include a cathode 210 and an anode 220 disposed to face the cathode 210. The electrode assembly 200 may further include a separator 230 interposed between the cathode 210 and the anode 220.

The cathode 210 and the anode 220 may be alternately and repeatedly stacked with the separator 230 interposed therebetween, thereby defining the electrode assembly 200.

In some embodiments, the secondary battery may include a jelly roll structure formed by repeatedly stacking a plurality of the electrode stacking structures or repeatedly winding an electrode assembly around a core pin (not shown).

In one embodiment, a stacking structure of the anode 220, the separator 230, and the cathode 210 may be placed on the core pin, and wound repeatedly around the core pin to form a jelly roll structure. The core pin may then be removed from the jelly roll structure to form the electrode assembly 200.

As shown in FIGS. 3 to 5, the cathode 210 may include a cathode current collector 212 and a cathode active material layer 214 disposed on at least one surface of the cathode current collector 212. In one embodiment, the cathode active material layers 214 may be respectively disposed on both surfaces of the cathode current collector 212.

The cathode current collector 212 may include stainless steel, nickel, aluminum, titanium, or an alloy thereof. The cathode current collector 212 may also include aluminum or stainless steel having a surface treated with carbon, nickel, titanium, or silver. For example, the cathode current collector 212 may have a thickness of 10 μm to 50 μm.

The cathode active material layer 214 may include a cathode active material.

For example, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

LiₓNiₐM_{b}O_{2+z} [Formula 1]

In Formula 1, x, a, b and z may satisfy 0.95≤x≤1.2, 0.5≤a≤0.99, 0.01≤b≤0.5, and −0.5≤z≤0.1. As described above, M may include Co, Mn and/or Al.

The chemical structure represented by Formula 1 indicates a bonding relationship between elements included in the layered structure or crystal structure of the cathode active material, and does not exclude other additional elements. For example, M includes Co and/or Mn, and Co and/or Mn may be provided as main active elements of the cathode active material together with Ni. Here, it should be understood that Formula 1 is provided to express the bonding relationship between the main active elements, and is a formula encompassing the introduction and substitution of additional elements.

In one embodiment, the cathode active material may further include auxiliary elements which are added to the main active elements, in order to enhance chemical stability thereof or the layered structure/crystal structure. The auxiliary element may be incorporated into the layered structure/crystal structure together with the main active elements to form a bond, and it should be understood that this case is also included within the chemical structure range represented by Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may serve as an auxiliary active element which contributes to the capacity/output activity of the cathode active material together with Co or Mn, such as Al.

For example, the cathode active material or the lithium-nickel metal oxide may include a layered structure or a crystal structure represented by Formula 1-1 below.

LiₓNiₐM1_{b1}M2_{b2}O_{2+Z} [Formula 1-1]

In Formula 1-1, M1 may include Co, Mn and/or Al. M2 may include the above-described auxiliary elements. In Formula 1-1, x, a, b1, b2 and z may satisfy 0.9≤x≤1.2, 0.5≤a≤0.99, 0.01≤b1+b2≤0.5, and −0.5≤z≤0.1.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of lithium-nickel metal oxide particles, or may penetrate through the surface of the lithium-nickel metal oxide particles to be incorporated into the bonding structure represented by Formula 1 or Formula 1-1 above.

The cathode active material may include a nickel-cobalt-manganese (NCM)-based lithium oxide. In this case, an NCM-based lithium oxide having an increased content of nickel may be used.

Ni may be provided as a transition metal associated with the output and capacity of the lithium secondary battery. Therefore, as described above, by employing a high-content (high-Ni) composition in the cathode active material, a high-capacity cathode and a high-capacity lithium secondary battery may be provided.

However, as the Ni content increases, the long-term storage stability and cycle life stability of the cathode 210 or the secondary battery may relatively decrease, and side reactions with the electrolyte may also increase. However, according to exemplary embodiments, the cycle life stability and capacity retention characteristics may be improved through Mn while maintaining electrical conductivity by including Co.

The content of Ni (e.g., the molar fraction of nickel based on the total molar amount of nickel, cobalt and manganese) in the NCM-based lithium oxide may be 0.5 or more, 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include, for example, a lithium (Li)-rich layered oxide (LLO)/over-lithiated oxide (OLO)-based active material, a manganese (Mn)-rich active material, or a cobalt (Co)-less active material, which have a chemical structure or a crystal structure represented by Formula 2 below. These may be used alone or in combination of two or more thereof.

p[Li₂MnO₃]·(1-p)[Li_{q}JO₂] [Formula 2]

In Formula 2, p and q may satisfy 0<p<1, and 0.95≤q≤1.2, and J may include at least one element selected from Mn, Ni, Co, Fe, Cr, V, Cu, Zn, Ti, Al, Mg and B.

The content of the cathode active material based on the total weight of the cathode active material layer 214 may be 40% by weight (“wt %”) or more, 50 wt % or more, 60 wt % or more, 70 wt % or more, 80 wt % or more, or 90 wt % or more.

The content of the cathode active material based on the total weight of the cathode active material layer 214 may be 99 wt % or less, 95 wt % or less, 90 wt % or less, or 85 wt % or less.

The above-described cathode active material may be mixed in a solvent to prepare a cathode slurry. The cathode slurry may be coated/deposited on at least one surface of the cathode current collector 212, and then dried and roll-pressed to prepare the cathode active material layer 214. The coating may include processes such as gravure coating, slot die coating, simultaneous multilayer die coating, imprinting, doctor blade coating, dip coating, bar coating or casting, etc.

Each cathode active material layer 214 may further include a binder, and optionally further include a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 214 may be decreased and the amount of the cathode active material may be relatively increased. Accordingly, the output characteristics and capacity characteristics of the secondary battery may be improved.

The cathode slurry may further include a thickener and/or dispersant. In one embodiment, the cathode slurry may include a thickener such as carboxymethyl cellulose (CMC).

The anode 220 may include an anode current collector 222, and an anode active material layer 224 disposed on at least one surface of the anode current collector 222. In one embodiment, the anode active material layers 224 may be respectively disposed on both surfaces of the anode current collector 222.

For example, the anode current collector 222 may include a copper foil, a nickel foil, a stainless steel foil, a titanium foil, a nickel foam, a copper foam, a polymer substrate coated with conductive metal and the like. These may be used alone or in combination of two or more thereof. For example, the anode current collector 222 may have a thickness of 10 μm to 50 μm.

The anode active material layer 224 may include an anode active material. As the anode active material, a material capable of intercalating and deintercalating lithium ions may be used. For example, as the anode active material, carbon-based materials such as crystalline carbon, amorphous carbon, carbon composite, or carbon fibers, etc.; lithium metal; a lithium alloy; a silicon (Si)-containing material or a tin (Sn)-containing material, etc. may be used. These may be used alone or in combination of two or more thereof.

The amorphous carbon may include hard carbon, soft carbon, coke, mesocarbon microbead (MCMB), mesophase pitch-based carbon fiber (MPCF) or the like.

The crystalline carbon may include graphite-based carbon such as natural graphite, artificial graphite, graphitized coke, graphitized MCMB, graphitized MPCF or the like.

The lithium metal may include pure lithium metal and/or lithium metal having a protective layer formed thereon for suppressing dendrite growth and the like. In one embodiment, a lithium metal-containing layer deposited or coated on the anode current collector 222 may also be used as the anode active material layer 224. In one embodiment, a lithium thin film layer may also be used as the anode active material layer 224.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity characteristics. The silicon-containing material may include Si, SiOₓ(0<x<2), metal-doped SiOₓ(0<x<2), a silicon-carbon composite, etc.

The metal may include lithium and/or magnesium, and the metal-doped SiOₓ(0<x<2) may include a metal silicate.

The anode active material may be mixed in a solvent to prepare an anode slurry. The anode slurry may be coated or deposited on the anode current collector 222, and then dried and roll-pressed to prepare the anode active material layer 224. The coating may include processes such as gravure coating, slot die coating, simultaneous multilayer die coating, imprinting, doctor blade coating, dip coating, bar coating or casting, etc. The anode active material layer 224 may further include a binder, and optionally may further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when preparing the cathode 210 as the binder, conductive material and thickener may also be used for the anode.

In some embodiments, a styrene-butadiene rubber (SBR)-based binder, carboxymethyl cellulose (CMC), polyacrylic acid-based binder, poly (3,4 ethylenedioxythiophene) (PEDOT)-based binder, and the like may be used as an anode binder. These may be used alone or in combination of two or more thereof.

The separator 230 may be configured to prevent an electrical short-circuit between cathode 210 and anode 220 and to allow the flow of ions. For example, the separator may have a thickness of 10 μm to 20 μm.

For example, separator 230 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separator 230 may also include a ceramic-based material. For example, inorganic particles may be coated on the polymer film or dispersed within the polymer film to improve heat resistance.

The separator 230 may have a single-layer or multi-layer structure including the above-described polymer film and/or non-woven fabric.

For example, the electrode assembly 200 may be accommodated in the case 100 together with an electrolyte to define a secondary battery. According to exemplary embodiments, a non-aqueous electrolyte may be used as the electrolyte.

The non-aqueous electrolyte may include a lithium salt of an electrolyte and an organic solvent, the lithium salt is represented by, for example, Li⁺X⁻, and as an anion (X⁻) of the lithium salt, F⁻, Cl⁻, Br⁻, I⁻, NO₃⁻; N(CN)₂⁻, BF₄⁻,ClO₄⁻, PF₆⁻, (CF₃)₂PF₄⁻, (CF₃)₃PF₃⁻, (CF₃)₄PF₂⁻, (CF₃)PF⁻, (CF₃)₆P⁻, CF₃SO₃⁻, CF₃CF₂SO₃⁻, (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₂SO₃⁻, CF₃CO₂⁻, CH₃CO₂⁻, SCN⁻ and (CF₃CF₂SO₂)₂N⁻, etc. may be exemplified.

The organic solvent may include, for example, propylene carbonate (PC), ethylene carbonate (EC), butylene carbonate, diethyl carbonate (DEC), dimethyl carbonate (DMC), ethyl methyl carbonate (EMC), methyl propyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (THEA), dibutyl ether, tetracthylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, diethoxyethane, sulfolane, gamma-butyrolactone, propylene sulfite and the like. These may be used alone or in combination of two or more thereof.

The non-aqueous electrolyte may further include an additive. The additive may include, for example, a cyclic carbonate compound, a fluorine-substituted carbonate compound, a sultone compound, a cyclic sulfate compound, a cyclic sulfite compound, a phosphate compound, a borate compound and the like. These may be used alone or in combination of two or more thereof.

The cyclic carbonate compound may include vinylene carbonate (VC), vinyl ethylene carbonate (VEC), etc.

The fluorine-substituted carbonate compound may include fluoroethylene carbonate (FEC), etc.

The sultone compound may include 1,3-propane sultone, 1,3-propene sultone, 1,4-butane sultone, etc.

The cyclic sulfate compound may include 1,2-ethylene sulfate, 1,2-propylene sulfate, etc.

The cyclic sulfite compound may include ethylene sulfite, butylene sulfite, etc.

The phosphate compound may include lithium difluoro bis(oxalato)phosphate, lithium difluoro phosphate, etc.

The borate compound may include lithium bis(oxalate) borate, etc.

In some embodiments, a solid electrolyte may be used in place of the above-described non-aqueous electrolyte. In this case, the lithium secondary battery may be manufactured in the form of an all-solid-state battery. In addition, a solid electrolyte layer may be disposed between the cathode 210 and the anode 220 in place of the above-described separator 230.

The solid electrolyte may include a sulfide-based electrolyte. As a non-limiting example, the sulfide-based electrolyte may include Li₂S—P₂S₅, Li₂S—P₂S₅—LiCl, Li₂S—P₂S₅—LiBr, Li₂S—P₂S₅—LiCl—LiBr, Li₂S—P₂S₅—Li2O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are positive numbers, Z is Ge, Zn or Ga), Li₂S—GeS₂, Li₂S—SiS₂—Li₃PO₄, Li₂S—SiS₂—Li_{q}MO_{q} (p and q are positive numbers, M is P, Si, Ge, B, Al, Ga or In), Li₇—xPS₆-xClₓ (0≤x≤2), Li₇-xPS₆—XBrₓ (0≤x≤2), Li₇-xPS₆—XIₓ (0≤x≤2), etc. These may be used alone or in combination of two or more thereof.

In one embodiment, the solid electrolyte may include an oxide-based amorphous solid electrolyte, such as, for example, Li₂O—B₂O₃—P₂O₅, Li₂O—SiO₂, Li₂O—B₂O₃, Li₂O—B₂O₃—ZnO, etc.

A cathode tab 215 may protrude from the cathode current collector 212 and extend toward the bottom surface or the cap plate 300 of the secondary battery. For example, a plurality of cathode tabs 215 may be electrically connected to form a cathode lead 217. For example, the cathode lead 217 may extend outwardly from the cap plate 300 or may be coupled to the cap plate 300 to serve as a cathode terminal of the secondary battery.

An anode tab 225 may protrude from the anode current collector 222 and extend toward the top surface of the secondary battery. For example, the anode tab 225 may protrude in a direction opposite to that of the cathode tab 215. For example, a plurality of anode tabs 225 may be electrically connected to form an anode lead 227. For example, the anode lead 227 may be electrically connected to the terminal part 130, such that the terminal part 130 may serve as an anode terminal of the secondary battery.

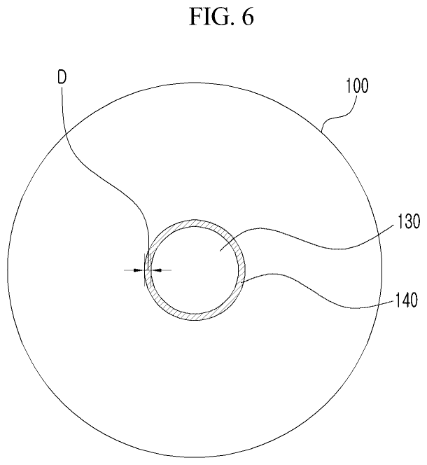

FIG. 6 is a schematic plan view of the secondary battery according to exemplary embodiments, as viewed from the top.

Referring to FIG. 6, at least a portion of the sealing member 140 may be exposed on the top surface of the case 100. Accordingly, a space between the terminal part 130 and the case 100 may be further sealed.

For example, the sealing member 140 may extend along the side surface of the exposure part 132 and/or the top surface of the case 100, such that the sealing member 140 may be exposed to the outside of the secondary battery.

In some embodiments, a length D by which the sealing member 140 protrudes outward from the exposure part 132 may be approximately 1 mm to 5 mm in a plan view, and in one embodiment, approximately 1 mm to 3 mm in the plan view. Within this range, the penetration of external moisture or impurities into the secondary battery may be further suppressed. As a result, the stability and long-term cycle life characteristics of the secondary battery may be further improved.

The planar direction may refer to a direction facing the top surface of the secondary battery or the case 100, as observed from above the top surface of the secondary battery or the case 100.

A secondary battery having improved sealing characteristics and reliability may be provided through the sealing member 140 without the need for a separate gasket or insulator.

FIGS. 7 to 9 are schematic perspective views for describing a method for manufacturing a sealing member included in the secondary battery according to exemplary embodiments.

Referring to FIGS. 7 to 9, the sealing member 140 may be formed by insert injection molding the terminal part 130.

Referring to FIG. 7, molds 10 and 20 for molding the sealing member 140 may be prepared. The molds 10 and 20 may include a first mold 10 and a second mold 20 facing each other. For example, a molded product may be formed between a first surface 10a of the first mold 10 and a second surface 20a of the second mold 20, which face each other.

For example, a groove 15 into which the terminal part 130 is inserted may be formed in the central portion of the first mold 10. A recess 25 into which a preliminary molded product is injected may be formed in the second surface 20a of the second mold 20.

The terminal part 130 may be inserted into and coupled to the first mold 10. The terminal part 130 may be provided as an insert in an insert injection process. For example, at least a portion of the body part of the terminal part 130 (e.g., the exposed part 132 and the insertion part 134) may be inserted into the groove 15.

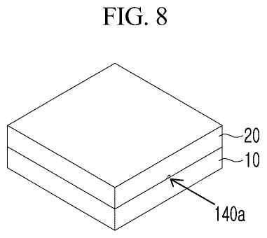

Referring to FIG. 8, the first mold 10, into which the terminal part 130 is inserted, and the second mold 20 may be coupled, and a preliminary molded product 140a may be injected through the recess 25 of the second mold 20. The preliminary molded product 140a may contain the same material as the sealing member 140. For example, the preliminary molded product 140a may be in a liquid form obtained by melting the above-described polymer at a high temperature.

The injection of the preliminary molded product 140a may be performed under high-pressure conditions. Accordingly, air present within the molds 10 and 20 may be rapidly discharged, thereby suppressing the formation of bubbles or defects within the molded product.

Thereafter, the molds 10 and 20 may be adjusted to a predetermined temperature to solidify the liquid preliminary molded product 140a. Accordingly, the molded product (the sealing member 140) may be formed.

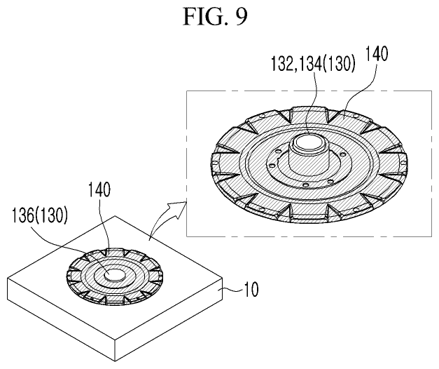

Referring to FIG. 9, the liquid preliminary molded product 140a may solidify and be bonded to the previously inserted terminal part 130. Accordingly, the terminal part 130 and the sealing member 140 may be formed as a substantially integrated member.

The terminal part 130 may partially fill the groove 15 of the first mold 10. Accordingly, the preliminary molded product 140a may also be injected and solidified between the terminal part 130 and the groove 15. Therefore, the sealing member 140 may entirely enclose the side surface of the terminal part 130.

According to some embodiments, the sealing member 140 may not cover the top surface of the head part 136 of the terminal part 130. For example, the sealing member 140 may be formed to enclose the lower surface of the head part 136 and the side surfaces of the exposure part 132 and the insertion part 134.

Therefore, as described above, the sealing member 140 may be manufactured integrally with the terminal part 130. Therefore, enhanced sealing and insulation can be provided by the terminal part 130 and the sealing member 140, thereby improving the structural stability and operational reliability of the secondary battery.

### DESCRIPTION OF REFERENCE NUMERALS

100: Case
110: Opening
120: Terminal hole
130: Terminal part
132: Exposure part
134: Insertion part
136: Head part
140: Sealing member
10: First mold
15: Groove
20: Second mold
25: Recess
140a: Preliminary molded product
200: Electrode assembly
210: Cathode
212: Cathode current collector
214: Cathode active material layer
215: Cathode tab
217: Cathode lead
220: Anode
222: Anode current collector
224: Anode active material layer
225: Anode tab
227: Anode lead
230: Separator
300: Cap plate

What is claimed is:

1. A secondary battery comprising:
a case comprising a terminal hole that penetrates a top surface thereof;
an electrode assembly accommodated in the case;
a terminal part inserted into the terminal hole; and
a sealing member that extends from the inside of the case to a region between the case and the terminal part, and is disposed between the case and the terminal part.

2. The secondary battery according to claim 1, wherein the sealing member extends along an inner surface of the case, a side surface of the terminal hole, and the top surface of the case.

3. The secondary battery according to claim 1, wherein the terminal part comprises an exposure part disposed on the top surface of the case and an insertion part inserted into the terminal hole.

4. The secondary battery according to claim 3, wherein the sealing member extends along an inner surface of the case and a side surface of the insertion part.

5. The secondary battery according to claim 4, wherein a diameter of the exposure part is equal to a diameter of the insertion part, and the sealing member further extends along a side surface of the exposure part.

6. The secondary battery according to claim 4, wherein a diameter of the exposure part is greater than a diameter of the insertion part, and the sealing member further extends along the top surface of the case.

7. The secondary battery according to claim 4, wherein a diameter of the exposure part is greater than a diameter of the insertion part, and the sealing member further extends along the top surface of the case and a side surface of the exposure part.

8. The secondary battery according to claim 3, wherein, a length by which the sealing member protrudes outward from the exposure part is 1 mm to 3 mm in a plan view.

9. The secondary battery according to claim 1, wherein the sealing member entirely encloses a side surface of the terminal part.

10. The secondary battery according to claim 1, wherein the sealing member electrically insulates the electrode assembly and the top surface of the case.

11. The secondary battery according to claim 1, wherein at least a portion of the sealing member is exposed on the top surface of the case.

12. The secondary battery according to claim 1, wherein the sealing member comprises a polymer.

13. The secondary battery according to claim 1, wherein the sealing member comprises at least one selected from the group consisting of high-density polyethylene, perfluoroalkoxy, a silicone polymer, and polybutylene terephthalate.

14. The secondary battery according to claim 1, wherein the sealing member is insert-molded into the terminal part.

15. The secondary battery according to claim 1, wherein the case comprises an opening that faces the top surface.

16. The secondary battery according to claim 15, further comprising a cap plate disposed in the opening and coupled to the case.
